(19) United States
(12) Patent Application Publication
(10) Pub. No.: US 2025/0198538 A1
(43) Pub. Date: Jun. 19, 2025

(54) VALVE FOR A REFRIGERATION APPLICATION

(71) Applicant: Danfoss A/S, Nordborg (DK)

(72) Inventors: Simon Ahrens LASSEN, Kolding (DK); Bjarke Skovgård DAM, Almind (DK); Yanning (Mars) SHEN, Wuqing (CN)

(21) Appl. No.: 18/847,729

(22) PCT Filed: Feb. 1, 2023
(86) PCT No.: PCT/EP2023/052453

§ 371 Date: Sep. 17, 2024

(30) Foreign Application Priority Data
Mar. 23, 2022 (DK) PA202200248

(51) Int. Cl. F16K 39/02; F16K 1/04; F16K 27/02; F16K 41/04; F25B 41/24

(52) U.S. Cl. CPC F16K 39/022; F16K 1/04; F16K 27/02; F16K 41/04; F25B 41/24

(57) ABSTRACT

A valve for a refrigeration application, in particular a shut-off and/or regulating valve including a bonnet connected to a housing with two fluid openings, a spindle fully penetrating the bonnet and reaching inside the housing, and a piston with an upper guiding and sealing portion with a seal section, a bottom closing portion for opening and closing a fluid passage between the two fluid openings, and a piston tube between the upper guiding and sealing portion and the bottom closing portion. The outer diameter of the piston tube is smaller than the outer diameters of the upper guiding and sealing portion and the bottom closing portion. The spindle engages the piston for moving it between a closed position and an open position of the valve. Additionally, a pressure balancing chamber is disclosed above and within the piston, said pressure balancing chamber being connected to the fluid passage via a pressure balancing passage, wherein the piston is supported by the spindle and the bonnet during at least some or all open positions of the valve, and wherein the piston is sealed against the bonnet at the upper guiding and sealing portion.

### CROSS-REFERENCES RELATED TO APPLICATIONS

This application is a National Stage application of International Patent Application No. PCT/EP2023/052453, filed on Feb. 1, 2023, which claims priority to Danish Patent Application No. PA202200248, filed on Mar. 23, 2022, each of which is hereby incorporated by reference in its entirety.

### TECHNICAL FIELD

The present invention pertains to a valve for a refrigeration application, in particular a shut-off and/or regulating valve.

### BACKGROUND

Valves for refrigeration applications are used for controlling refrigeration fluid flows between high pressure and low pressure portions of the applications. They are typically operated at high pressure gradients. During the opening and closing of the valve, the valve piston experiences considerable radial forces due to the high pressure gradient. These radial forces inhibit the axial movement of the piston and make it harder to open and close the valve.

### SUMMARY

The aim of the present invention is to overcome this problem and to provide an improved valve, which allows smooth-running movement of the piston, even when exposed to high pressure gradients.

This aim is reached by the valve according to claim 1. Preferable embodiments are subject to the dependent claims.

According to claim 1, a valve for a refrigeration application is provided. The valve may be a shut-off and/or regulating valve, comprising a bonnet connected to a housing with two fluid openings and a spindle fully penetrating the bonnet and reaching inside the housing. The spindle may be formed integrally or may comprise any number of connected subcomponents. The valve further comprises a piston with an upper guiding and sealing portion with a seal section, a bottom closing portion for opening and closing a fluid passage between the two fluid openings, and a piston tube between the upper guiding and sealing portion and the bottom closing portion, wherein the outer diameter of the piston tube is smaller than the outer diameters of the upper guiding and sealing portion, wherein the spindle engages the piston for moving it between a closed position and an open position of the valve, wherein a pressure balancing chamber is provided above and within the piston, said pressure balancing chamber being connected to the fluid passage via a pressure balancing passage, wherein the piston is supported by the spindle and the bonnet during at least some or all open positions of the valve, and wherein the piston is sealed against the bonnet at the upper guiding and sealing portion. The piston may be sealed against the bonnet only at the upper guiding and sealing portion. In a closed state of the valve, the fluid passage is shut off by the piston, such that no fluid can flow between the two fluid openings.

A major advantage of the claimed valve is that the piston tube has a diameter that is significantly reduced compared to the guiding and sealing portion and compared to the bottom closing portion, providing a lot of space around the piston tube. This means that a high pressure gradient acting on the piston tube acts on its considerably reduced surface area, i.e. in a radial direction of the piston, compared to valves known from prior art. As a result, the forces acting on the piston tube in a radial direction are reduced. The radial direction of the piston is parallel to a plane orthogonal to the longitudinal direction of the piston tube.

Also, due to the reduced diameter of the piston tube, a larger volume for fluid flow is provided between the housing and the piston tube. This also reduce the likelihood of turbulences around the piston tube, further increasing the valve performance.

Furthermore, the spindle is provided such that it seals the valve in its fully open position. The claimed valve makes it possible to maintain small overall valve dimensions and in particular a small housing, keeping the price of the valve low.

In a preferred embodiment of the invention, the pressure balancing passage is provided within the spindle and/or within the piston and/or the outer diameter of the pressure balancing chamber corresponds to the outer diameter of the upper guiding and sealing portion and/or the valve is a service valve and/or a sliding sleeve is provided between the piston and the bonnet.

The pressure balancing passage may be a single passage leading through one or more channels in the spindle and further through one or more channels in components of the piston such as the bottom closing portion. Alternatively, the pressure balancing passage may only lead through either of the spindle or the bottom closing portion. Furthermore, the pressure balancing passage may be understood to comprise more than one fluid connection between the pressure balancing chamber and the fluid passage.

The outer diameter of the pressure balancing chamber corresponds to the widest portion of the pressure balancing chamber in a radial direction of the valve. The pressure balancing chamber may be bound by the piston, the spindle and the bonnet. It is variable in size and volume, depending on the position of the piston relative to the bonnet. It may be shaped such that its outer diameter equals the outer diameter of the upper guiding and sealing portion.

In another preferred embodiment of the invention, the seal section comprises at least one or exactly two seals (49′, 49″). Alternatively, at least one seal (49′, 49″) is or exactly two seals (49′, 49″) are fixedly coupled to the bonnet. The seals may be coupled either to the seal section of the piston's upper guiding and sealing portion or to the bonnet. In the case, in which the seals are coupled to the piston, the seals move together with the piston as the valve is opened or closed. In the case, in which the seals are coupled to the bonnet, the seals remain stationary with the bonnet as the piston moves past the seals when opening or closing the valve.

In another preferred embodiment of the invention, the upper guiding and sealing portion comprises only the extreme end of the piston and/or corresponds to less than half, preferably less than a fourth or less than a fifth of the entire length of the piston. The upper guiding and sealing portion comprises the seal section and is the upper portion of the piston. It is situated opposite the bottom closing portion, which closes the fluid passage against a valve seat at the valve housing. The upper guiding and sealing portion may be integrally formed with the piston tubeth and/or may be the widest portion of the piston tube. Alternatively, the upper guiding and sealing portion may be wider than the piston tube and narrower than the bottom closing portion. The upper guiding and sealing portion may be formed as a hollow cylindrical portion of the piston tube. The upper guiding and sealing portion may comprise at least one and preferably two external grooves for accommodating at least one seal.

In another preferred embodiment of the invention, the piston is sealed against the bonnet only at the upper guiding and sealing portion. Providing the sealing at the upper guiding and sealing portion makes it possible to reduce the size of the piston and bonnet for a given valve diameter.

In another preferred embodiment of the invention, the pressure balancing chamber is connected to the fluid passage via a pressure balancing passage within the spindle and/or within the bottom closing portion. There may be one single pressure balancing passage or two or more parallel pressure balancing passages.

In another preferred embodiment of the invention, the bonnet comprises two concentric protrusions formed as hollow cylinders, between which the upper guiding and sealing portion is at least partially guided. The two concentric protrusions, one internal, one external, may extend in parallel to the spindle. The bonnet may be connected to the housing via the outside of the external protrusion. The inside of the external protrusion may be provided for guiding the upper guiding and sealing portion.

In another preferred embodiment of the invention, the bonnet is formed integrally and/or inserted partially into the housing and/or connected directly to the housing. The direct connection of the bonnet to the housing may mean that there are no other components between the bonnet and the housing in this embodiment.

In another preferred embodiment of the invention, the spindle is rotatably coupled to the piston tube via balls. The balls facilitate the relative rotation of the two components and simultaneously lock the two components to each other for their parallel axial movement. The balls transmit a force from the spindle to the piston while the spindle is turned and axially displaced. The rotational aspect of the ball connection between the spindle and the piston tube is secondary compared to the coupling of the spindle to the piston tube provided by the balls. The main purpose of the balls is to connect the spindle to the piston so that the two parts are lifted together, when the spindle is turned and moved upwards.

In another preferred embodiment of the invention, a bushing is provided at or close to an extreme end of the spindle and between the spindle and the bottom closing portion. The bushing facilitates the relative rotational movement of the spindle with respect to the piston. The bushing may be coplanar to a bottom face of the spindle. The bushing may have the same external radius as an adjacent portion of the spindle.

In another preferred embodiment of the invention, the bottom closing portion comprises an outer flange and an inner flange between which a sealing element is provided. The two flanges may be screwed to each other. The inner flange may be formed integrally with the piston tube. The outer diameter of the sealing element may be larger than the outer diameter of the outer flange and smaller than the outer diameter of the inner flange.

### BRIEF DESCRIPTION OF THE DRAWINGS

Further advantages and details of the invention are described with reference to the figures. The figures show:

FIG. 1 is a sectional view of the valve in its closed position;

FIG. 2 is a sectional view of the valve in its open position;

FIG. 3 is a schematic view of an embodiment of the valve; and

FIG. 4 is a schematic view of another embodiment of the valve.

### DETAILED DESCRIPTION

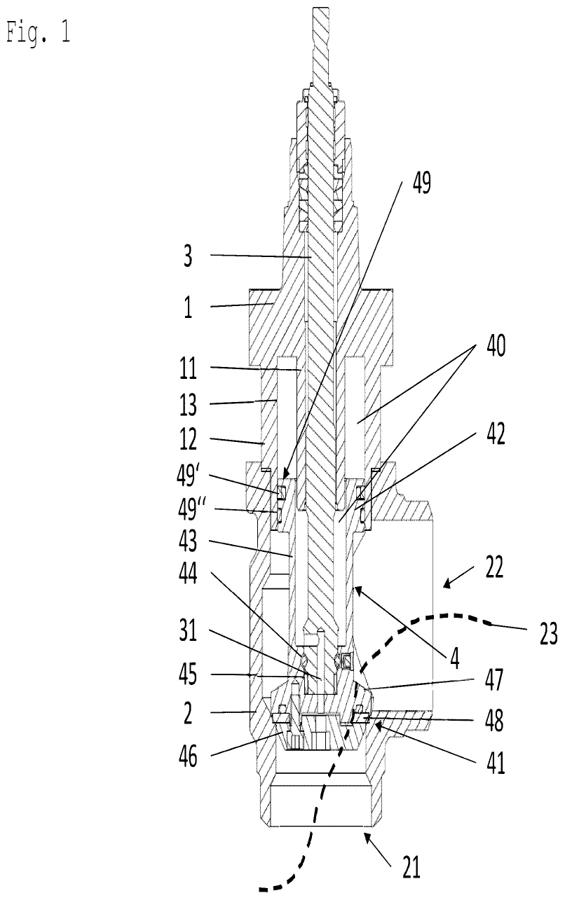

FIG. 1 shows a sectional view of an embodiment of the presently described valve in its closed position. The valve may be a shut-off and/or regulating valve. It comprises a bonnet 1 and a housing 2, connected to each other. The housing 2 comprises two fluid openings 21, 22. The fluid openings may be angled to each other. A spindle 3 fully penetrates the bonnet 1 and reaches inside the housing 2. The spindle 3 may be formed integrally or may comprise any number of connected subcomponents. The spindle 3 comprises a threaded portion such that it may be turned in order to translate the spindle 3 in an axial direction of the valve. The axial direction of the valve may correspond to the longitudinal direction of the spindle 3. A radial and circumferential direction of the valve may also be referenced to the spindle 3 and may correspond to the radial and circumferential direction of the spindle 3.

The valve comprises a piston 4 with an upper guiding and sealing portion 42 with a seal section 49, a bottom closing portion 41 for opening and closing a fluid passage 23 between the two fluid openings 21, 22, and a piston tube 43 between the upper guiding and sealing portion 42 and the bottom closing portion 41. The piston 4 is shown in a fully closed position of the valve, in which the bottom closing portion 41 is in contact with the housing 2 for closing the fluid passage 23.

The outer diameter of the piston tube 43 is smaller than the outer diameters of the upper guiding and sealing portion 42 and the bottom closing portion 41. This means that, compared to prior art solutions, the space between the outside of the piston tube 43 and the inside of the housing 2 is enlarged without increasing the size of the housing and therefore without increasing material costs.

The reduced outer diameter of the piston tube 43 results in a reduced surface area of the piston tube 43, across which a pressure gradient can act, in particular in a radial direction of the piston. In return, this results in reduced forces acting on the entire piston 4 during high pressure gradient situations, such as during the initial opening phase or the final closing phase of the valve.

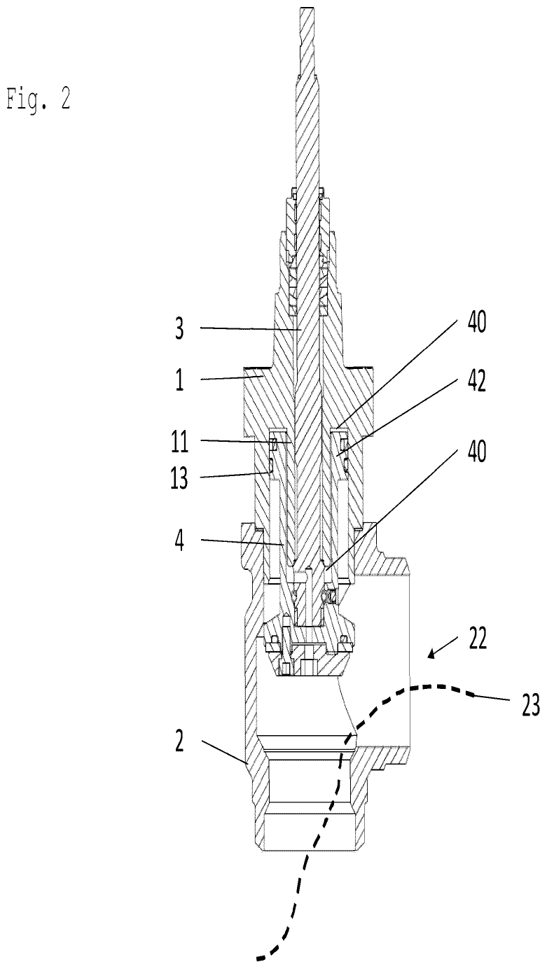

The spindle 3 engages the piston 4 for moving it between the closed position shown in FIG. 1 and an open position of the valve shown in FIG. 2, in which the piston 4 has been moved away from the bottom of the housing 2.

A pressure balancing chamber 40 is provided above and within the piston 4. The pressure balancing chamber 40 may vary in size and shape in dependence on the opening state of the valve.

The pressure balancing chamber 40 may comprise two large hollow cylindrical sub-chambers, an external hollow cylindrical sub-chamber and an internal hollow cylindrical sub-chamber, which are connected via an intermediate hollow cylindrical sub-chamber in a closed state of the valve. The internal hollow cylindrical sub-chamber may be the radially innermost sub-chamber and the external hollow cylindrical sub-chamber may be the radially outermost sub-chamber. The pressure balancing chamber 40 is connected to the fluid passage 23 via a pressure balancing passage 31. The pressure balancing passage 31 may be aligned at least partially along a central axis of the spindle 3.

The piston 4 is supported by the spindle 3 and the bonnet 1 during at least some or all open positions of the valve. The piston 4 is sealed against the bonnet 1 at the upper guiding and sealing portion 42. In the closed state of the valve shown in FIG. 1, the fluid passage 23 is shut off by the piston 4, such that no fluid can flow between the two fluid openings 21, 22. The pressure balancing passage 31 fluidly connects the pressure balancing chamber 40 to the bottom fluid opening 21, such that pressure balancing of the piston 4 with respect to the pressure at the bottom fluid opening 21 is achieved. Pressure balancing of the piston 4 requires two elements. The first element is that equal pressure is acting on two opposing ends of the piston 4. This is achieved by the passage 31. The second element is that the pressure acts on both sides of the piston 4 on the same effective area or the same area projected on a horizontal plane with respect to the axis of the piston 4.

The pressure balancing passage 31 is provided within the spindle 3 and within the piston 4 in the embodiment of FIG. 1. Other embodiments may comprise a pressure balancing passage 31 which is located only within the piston's 4 structure, e.g. within the bottom closing portion 41.

The outer diameter of the pressure balancing chamber 40 may correspond to the outer diameter of the upper guiding and sealing portion 42 and provide a sliding fit with respect to the inner diameter of an outer concentric protrusion 12, within which the piston 4 is slidable. The valve may be a service valve of a refrigeration application.

The outer diameter of the pressure balancing chamber 40 may also correspond to the widest portion of the pressure balancing chamber 40 in a radial direction of the valve. The pressure balancing chamber 40 may be bound by the piston 4, the spindle 3 and the bonnet 1. In particular, it may be bound by an internal cylindrical face of the piston 4 and two circular planar portions of the piston 4, one at the upper guiding and sealing portion 42 and another close to an opposite side of the piston 4.

The pressure balancing passage 31 may be a single passage leading through a channel in the spindle 3 and further through channels in other components of the piston 4 such as the bottom closing portion 41. Alternatively, the pressure balancing passage 31 may only lead through either of the spindle 3 or the bottom closing portion 41. A first portion of the pressure balancing passage 31 in the spindle 3 may extend in a radial direction, while a second portion of the pressure balancing passage 31 may extend in an axial direction. In another embodiment, the pressure balancing passage 31 may be understood to comprise more than one fluid connection between the pressure balancing chamber 40 and the fluid passage 23.

The seal section 49 may be part of the upper guiding and sealing portion 42 and may comprises at least one or exactly two seals 49′, 49″. In particular, the seal section may comprise the radially outer part of the upper guiding and sealing portion 42. In the embodiment of FIG. 1, the seals 49′, 49″ are coupled to the piston 4. The seal section 49 comprises circumferential groves, in which the seals 49′, 49″ are at least partially situated. The seals 49′, 49″ move together with the piston 4 as the valve is opened or closed.

The upper guiding and sealing portion 42 comprises only the extreme end of the piston 4. It may correspond to less than half, preferably less than a fourth or less than a fifth of the entire length of the piston 4. The length of the piston 4 may be understood as its axial extension. The upper guiding and sealing portion 42 comprises the seal section 49 and is the upper portion of the piston 4. It is situated opposite the bottom closing portion 41, which closes the fluid passage 23 against a valve seat at the valve housing 2. The upper guiding and sealing portion 42 may be integrally formed with the piston tube 43 and/or may be the widest portion of the piston tube 43. An upwards facing side of the upper guiding and sealing portion 42 may have the same diameter or a similar diameter to a downwards facing side of the bottom closing portion 41, in particular to an outer flange 46 of the bottom closing portion 41. The upward facing surface area of the pressure balancing chamber 40 may be chosen such that a pressure gradient with respect to the downward facing surface of the bottom closing portion 41 can be balanced effectively. The upward facing surface area of the pressure balancing chamber 40 may be chosen to equal the downward facing surface of the bottom closing portion 41 exposed to the pressure at the bottom fluid opening 21 in a closed position of the valve.

The upper guiding and sealing portion 42 may be formed as a hollow cylindrical portion connected to the piston tube 43. The upper guiding and sealing portion 42 may comprise at least one and preferably two external grooves for accommodating at least one seal 49′, 49″. The inside of the upper guiding and sealing portion 42 may align with the inside of the piston tube 43.

The piston 4 is sealed against the bonnet 1 only at the upper guiding and sealing portion 42. Providing the sealing at the upper guiding and sealing portion makes it possible to reduce the size of the piston 4 and bonnet 1 for a given valve diameter.

The pressure balancing chamber 40 is connected to the fluid passage 23 via a pressure balancing passage 31 within the spindle 3 and within the bottom closing portion 41. There may be one single pressure balancing passage 31 or two or more parallel pressure balancing passages 31 in other embodiments.

The bonnet 1 comprises two concentric protrusions 11, 12 formed as hollow cylinders, between which the upper guiding and sealing portion 42 is at least partially guided. The outer concentric protrusion 12 may extend further than the inner concentric protrusion 11 in an axial direction of the valve.

The two concentric protrusions 11, 12 extend in parallel to the spindle 3. The bonnet 1 may be connected to the housing 2 via the outside of the external protrusion 12. The inside of the external protrusion 12 may be provided for guiding the upper guiding and sealing portion 42. The length of the external protrusion 12 may correspond to the distance of the valve stroke combined with the axial extension of the upper guiding and sealing portion 42.

The bonnet 1 is formed integrally and inserted partially into the housing 2. When connected, the bonnet 1 and the housing 2 overlap over a distance, which is larger than the axial extension of the upper guiding and sealing portion 42. The bonnet 1 may be screwed into the housing 2.

In the embodiment of FIG. 1, the bonnet 1 is connected directly to the housing 2. The direct connection of the bonnet 1 to the housing 2 means that these components are in direct contact with each other.

The spindle 3 is coupled, preferably rotatably coupled, to the piston tube 43 via balls 44. The balls 44 facilitate the relative rotation of the two components and simultaneously lock the two components to each other for their parallel axial movement. The balls 44 are located between a port of the pressure balancing passage 31 leading into the spindle 3 and the bottom end of the spindle 3. The balls 44 transmit a force from the spindle 3 to the piston 4 while the spindle 3 is turned and axially displaced for operating the valve.

A bushing 45 is provided at an extreme end of the spindle 3 and between the spindle 3 and the bottom closing portion 41. The bushing 45 facilitates the relative rotational movement of the spindle 3 with respect to the piston 4. The bushing 45 is coplanar to a bottom face of the spindle 3. The bushing 45 may have the same external radius as an adjacent portion of the spindle 3.

The bottom closing portion 41 comprises an outer flange 46 and an inner flange 47 between which a sealing element 48 is provided. The inner flange 47 may be formed integrally with the piston tube 43. The two flanges 46, 47 may be screwed to each other by means of screws. The outer diameter of the sealing element 48 may be larger than the outer diameter of the outer flange 46 and smaller than the outer diameter of the inner flange 47.

FIG. 2 shows a sectional view of the valve in its fully open position. The upper guiding and sealing portion 42 is moved away from the housing 2 and into the bonnet 1. The spindle 3 abuts the bottom portion of the inner concentric protrusion 11. The contact between the spindle 3 and the bottom portion of the inner concentric protrusion 11 seals the valve against the outside in the open position of the valve. As can be seen from a comparison of FIG. 1 and FIG. 2, the pressure balancing chamber 40 is greatly reduced in volume in the open position of the valve shown in FIG. 2. The size and shape of the pressure balancing chamber 40 depend on the position of the piston 4 relative to the bonnet 1.

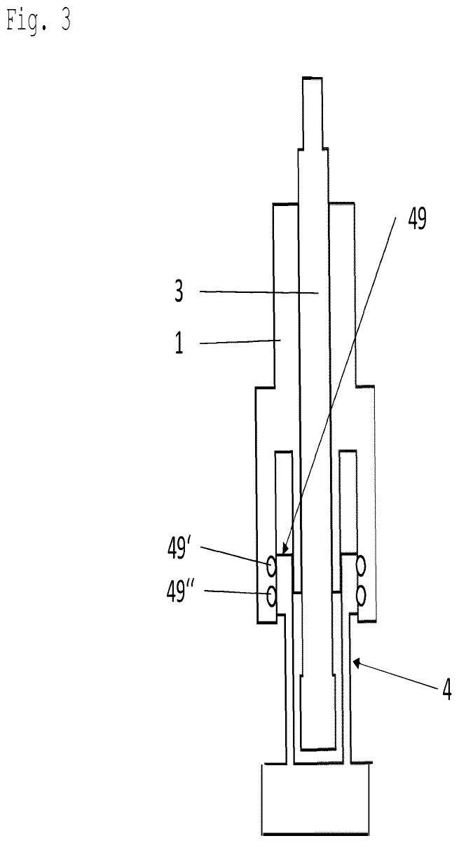

FIG. 3 is a schematic view of an embodiment of the valve, in which two seals 49′, 49″ are fixedly coupled to the bonnet 1 instead of the piston 4. In this embodiment, the seals 49′, 49″ remain stationary with the bonnet 1 as the piston 4 moves past the seals 49′, 49″ when opening or closing the valve.

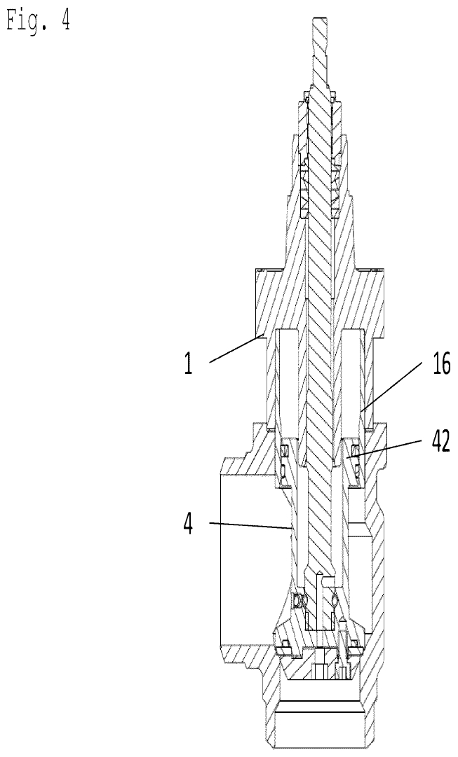

FIG. 4 is a schematic view of another embodiment of the valve. Here, a sliding sleeve 16 is provided between the piston 4 and the bonnet 1. The upper guiding and sealing portion 42 moves along this sliding sleeve 16, such that there is no direct contact between the bonnet 1 and the upper guiding and sealing portion 42. The sliding sleeve 16 may be at least partially inserted into the bonnet 1 and/or may be welded or connected otherwise to the bonnet 1.

The invention may be carried out with various combinations of the features of the presently described embodiments.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A valve for a refrigeration application, in particular a shut-off and/or regulating valve, comprising a bonnet connected to a housing with two fluid openings, a spindle fully penetrating the bonnet and reaching inside the housing, and a piston with an upper guiding and sealing portion with a seal section, a bottom closing portion for opening and closing a fluid passage between the two fluid openings, and a piston tube between the upper guiding and sealing portion and the bottom closing portion, wherein the outer diameter of the piston tube is smaller than the outer diameters of the upper guiding and sealing portion and the bottom closing portion, wherein the spindle engages the piston for moving it between a closed position and an open position of the valve, wherein a pressure balancing chamber is provided above and within the piston, said pressure balancing chamber being connected to the fluid passage via a pressure balancing passage, wherein the piston is supported by the spindle and the bonnet during at least some or all open positions of the valve, and wherein the piston is sealed against the bonnet at the upper guiding and sealing portion.

2. The valve according to claim 1, wherein the pressure balancing passage is provided within the spindle and/or within the piston and/or that the outer diameter of the pressure balancing chamber corresponds to the outer diameter of the upper guiding and sealing portion and/or that the valve is a service valve and/or that a sliding sleeve is provided between the piston and the bonnet.

3. The valve according to claim 1, wherein the seal section comprises at least one or exactly two seals or that at least one seal is or exactly two seals are fixedly coupled to the bonnet.

4. The valve according to claim 1, wherein the upper guiding and sealing portion comprises only the extreme end of the piston and/or corresponds to less than half, preferably less than a fourth or less than a fifth of the entire length of the piston.

5. The valve according to claim 1, wherein the piston is sealed against the bonnet only at the upper guiding and sealing portion.

6. The valve according to claim 1, wherein the pressure balancing chamber is connected to the fluid passage via a pressure balancing passage within the spindle and/or within the bottom closing portion.

7. The valve according to claim 1, wherein the bonnet comprises two concentric protrusions formed as hollow cylinders, between which the upper guiding and sealing portion is at least partially guided.

8. The valve according to claim 1, wherein the bonnet is formed integrally and/or inserted partially into the housing and/or connected directly to the housing.

9. The valve according to claim 1, wherein the spindle is coupled, preferably rotatably coupled, to the piston tube via balls.

10. The valve according to claim 1, wherein a bushing is provided at or close to an extreme end of the spindle and between the spindle and the bottom closing portion.

11. The valve according to claim 1, wherein the bottom closing portion comprises an outer flange and an inner flange between which a sealing element is provided.

12. The valve according to claim 2, wherein the seal section comprises at least one or exactly two seals or that at least one seal is or exactly two seals are fixedly coupled to the bonnet.

13. The valve according to claim 2, wherein the upper guiding and sealing portion comprises only the extreme end of the piston and/or corresponds to less than half, preferably less than a fourth or less than a fifth of the entire length of the piston.

14. The valve according to claim 3, wherein the upper guiding and sealing portion comprises only the extreme end of the piston and/or corresponds to less than half, preferably less than a fourth or less than a fifth of the entire length of the piston.

15. The valve according to claim 2, wherein the piston is sealed against the bonnet only at the upper guiding and sealing portion.

16. The valve according to claim 3, wherein the piston is sealed against the bonnet only at the upper guiding and sealing portion.

17. The valve according to claim 4, wherein the piston is sealed against the bonnet only at the upper guiding and sealing portion.
